(19) United States
(12) Patent Application Publication
(10) Pub. No.: US 2026/0167246 A1
(43) Pub. Date: Jun. 18, 2026

(54) CHILD TRANSPORTER INCLUDING CARRIER COVER

(71) Applicant: Dorel Juvenile Group, Inc., Foxboro, MA (US)

(72) Inventors: Trevor Warren LAROCHELLE, Foxboro, MA (US); Loan Thi Ngoc NGUYEN, Foxboro, MA (US); Jennifer KELLY, Foxboro, MA (US)

(21) Appl. No.: 19/423,377

(22) Filed: Dec. 17, 2025

Related U.S. Application Data
(60) Provisional application No. 63/735,426, filed on Dec. 18, 2024.
(60) Provisional application No. 63/876,440, filed on Sep. 5, 2025.

(51) Int. Cl. B62B 9/14; B62B 7/00; B62B 9/10

(52) U.S. Cl. CPC B62B 9/142; B62B 9/102; B62B 7/008

(57) ABSTRACT

A child transporter includes a frame and a child carrier. The frame includes a chassis, a plurality of wheels coupled to the chassis to support the chassis above ground, and a handle coupled to the chassis. The child carrier is configured to hold a child for transportation. The child transporter is configured to be used to transport the child over ground.

### PRIORITY CLAIM

This application claims priority under 35 U.S.C. § 119(e) to U.S. Provisional Patent Application No. 63/735,426 , filed Dec. 18, 2024 and to U.S. Provisional Patent Application No. 63/876,440 , filed Sep. 5, 2025, the disclosure of each of which is expressly incorporated by reference herein in its entirety.

### BACKGROUND

The present disclosure relates to a child safety device, and particularly to a child seat. More particularly, the present disclosure relates to a child transporter including a child seat.

### SUMMARY

According to the present disclosure, a child transporter including a frame including a chassis, a plurality of wheels coupled to the chassis to support the chassis above ground, and a handle coupled to the chassis and configured to be gripped and maneuvered by a user to move the frame over the ground. The child transporter also includes a child carrier coupled to the chassis and formed to include a child-receiving space configured to hold a child to transport the child, the child carrier including a child seat having a seating surface for the child and a footrest coupled to the child seat to support legs of the child and formed to include a carrier-cover compartment.

In illustrative embodiments, the child transporter also includes a carrier cover coupled with the footrest and movable from a storage configuration, in which the carrier cover is stored in the carrier-cover compartment of the footrest, and an expanded configuration, in which the carrier cover is withdrawn from the carrier-cover compartment and attaches to portions of the child seat to provide an enclosed space at least partially surrounding the child.

In illustrative embodiments, the footrest includes a top cover and a bottom cover and the carrier-cover compartment is located between the top cover and the bottom cover. The top cover may be pivotable about a horizontal axis to open the carrier-cover compartment. The carrier cover is attached near a distal end of the bottom cover.

In illustrative embodiments, in the storage configuration, the carrier cover displaces the top cover in an upward direction to separate the top cover from the bottom cover, and, in the expanded configuration, the top cover engages an upper surface of the bottom cover to lower an upper surface of the top cover and provide increased space in the upward direction between the carrier cover and the top cover in the expanded configuration. The child seat may be pivotable relative to the frame between an upright-seating position and a laid-back position to arrange the child seat in a bassinet mode when the carrier cover is in the expanded configuration and the child seat is in the laid-back position.

In illustrative embodiments, the carrier cover includes a top panel, a first side panel coupled to a first lateral side of the top panel and a first lateral side of the child seat in the expanded configuration, and a second side panel coupled to a second lateral side of the top panel and a second lateral side of the child seat in the expanded configuration. The carrier cover may further include a plurality of zippers interconnecting the first and second side panels to the top panel and to the child seat. Each zipper includes a zipper head, a zipper track configured to be opened and closed by the zipper head, and a zipper tether coupled to the zipper head to engage selectively with a corresponding retainer on the child seat to the zipper in a closed position when the carrier cover is in the expanded configuration.

In illustrative embodiments, the top panel includes a flexible sheet and a plurality of relatively rigid supports coupled to the top sheet. The rigid supports extend between the first lateral side of the top cover and the second lateral side of the top cover to block sagging of the top cover in a downward direction toward the seating surface in the expanded configuration. Each of the rigid supports may be curved.

According to the present disclosure, a child restraint including a child seat having a seating surface for a child, a footrest coupled to the child seat to support legs of the child and formed to include a carrier-cover compartment, and a carrier cover coupled with the footrest and movable from a storage configuration, in which the carrier cover is stored in the carrier-cover compartment of the footrest, and an expanded configuration, in which the carrier cover is withdrawn from the carrier-cover compartment and attaches to portions of the child seat to provide an enclosed space at least partially surrounding the child.

In illustrative embodiments, the footrest includes a top cover and a bottom cover and the carrier-cover compartment is located between the top cover and the bottom cover. The top cover may be pivotable about a horizontal axis to open the carrier-cover compartment. The carrier cover is attached near a distal end of the bottom cover.

In illustrative embodiments of the child restraint, in the storage configuration, the carrier cover displaces the top cover in an upward direction to separate the top cover from the bottom cover, and, in the expanded configuration, the top cover engages an upper surface of the bottom cover to lower an upper surface of the top cover and provide increased space in the upward direction between the carrier cover and the top cover in the expanded configuration. The child seat may be pivotable relative to the frame between an upright-seating position and a laid-back position to arrange the child seat in a bassinet mode when the carrier cover is in the expanded configuration and the child seat is in the laid-back position.

In illustrative embodiments of the child restraint, the carrier cover includes a top panel, a first side panel coupled to a first lateral side of the top panel and a first lateral side of the child seat in the expanded configuration, and a second side panel coupled to a second lateral side of the top panel and a second lateral side of the child seat in the expanded configuration. The carrier cover may further include a plurality of zippers interconnecting the first and second side panels to the top panel and to the child seat. Each zipper includes a zipper head, a zipper track configured to be opened and closed by the zipper head, and a zipper tether coupled to the zipper head to engage selectively with a corresponding retainer on the child seat to the zipper in a closed position when the carrier cover is in the expanded configuration.

In illustrative embodiments of the child restraint, the top panel includes a flexible sheet and a plurality of relatively rigid supports coupled to the top sheet. The rigid supports extend between the first lateral side of the top cover and the second lateral side of the top cover to block sagging of the top cover in a downward direction toward the seating surface in the expanded configuration. Each of the rigid supports may be curved.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a top perspective view of a child transporter including a frame, and a child carrier coupled with the frame and including child seat having a seating surface configured to support a child thereon and a footrest coupled to the child seat and configured to support legs of the child;

FIG. 2 is a top perspective view of the child transporter of FIG. 1, showing the footrest formed to include a carrier-cover compartment and showing the child transporter further including a carrier cover withdrawn from the carrier-cover compartment;

FIG. 3 is a top perspective view of the child transporter of FIG. 1, showing the carrier cover in an expanded configuration to provide an enclosed space at least partially surrounding the child seated in the child seat;

FIG. 4 is a perspective view of portions of the child transporter showing the footrest of FIG. 1 and the carrier cover in a storage configuration received in the carrier-cover compartment;

FIG. 5 is a perspective view of portions of the child transporter of FIG. 1, showing soft goods folded to expose a top cover of the footrest overlying the carrier cover in the storage configuration;

FIG. 6 is a perspective view of portions of the child transporter of FIG. 1 showing the top cover unfolded to open the carrier-cover compartment and the carrier cover unfolded from the carrier-cover compartment;

FIG. 7 is a perspective view of portions of the child transporter of FIG. 1 showing the top cover folded downward to overly a bottom cover of the footrest and increase a vertical space of the footrest;

FIG. 8 is a perspective view of portions of the child transporter of FIG. 1 showing a side panel of the carrier cover being attached to a later edge of the child seat;

FIG. 9 is a perspective view of portions of the child transporter showing a zipper head attached to a zipper tether to retain the zipper in a closed position;

FIG. 10 is a perspective view of portions of the child transporter showing a top panel of the carrier cover being attached to an edge of the first side panel of the carrier cover;

FIG. 11 is a perspective view of portions of the child transporter showing the top panel being attached to an edge of a second side panel of the carrier cover;

FIG. 12 is a front perspective view of a second illustrative embodiment of a child transporter including a first child carrier and a second child carrier positioned side-by-side on a frame and showing each child carrier including a footrest and a carrier cover configured to be deployed to an expanded configuration to provide an enclosed space at least partially surrounding a child seated in the child carriers;

FIG. 13 is a front perspective view of a third illustrative embodiment of a child transporter, including a rolling stroller frame, a child carrier, and a carrier cover in storage configuration;

FIG. 14 is a front perspective view of the child transporter of FIG. 13, showing the carrier cover being removed from the carrier-cover compartment from a lower end of a footrest of the child carrier;

FIG. 15 is a front perspective view of the child transporter of FIG. 13 suggesting movement of the carrier cover in an upward direction toward an expanded configuration; and

FIG. 16 is a front perspective view of the child transporter of FIG. 15 showing a carrier cover in the expanded configuration surrounding at least partially a child receiving space of the child carrier.

### DETAILED DESCRIPTION

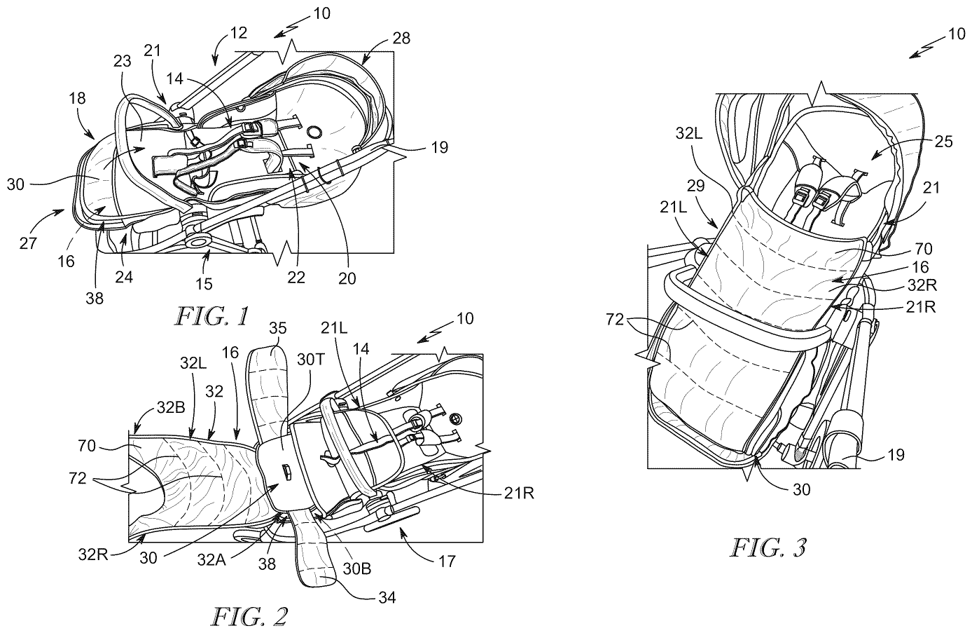

A child transporter 10 includes a frame 12 and a child carrier 14 as shown in FIGS. 1-3. The frame 12 is configured to support the child carrier 14 above ground and for transportation over the ground. The frame 12 includes a chassis 15, a plurality of wheels 17 coupled to the chassis 15 to support the chassis 15 above ground, and a handle 19 coupled to the chassis 15 and configured to be gripped and maneuvered by a user to move the frame 12 over the ground. The child carrier 14 (also called a child restraint or child seat) is configured to hold a child for transportation. In the illustrative embodiment, the child transporter 10 is a juvenile stroller, a wagon, or any other suitable transportation device for a child.

The child carrier 14 is coupled to the chassis 15 and formed to include a child-receiving space 22 configured to hold a child to transport the child. The child carrier 14 includes a child seat 21 and a footrest 30 coupled to the child seat 21 as shown in FIGS. 1-3. The child seat 21 includes a seating surface 23 for the child. The footrest 30 is configured to support legs of the child and is formed to include a carrier-cover compartment 38. In some embodiments, the child carrier 14 may be coupled to another device for transportation, such as a vehicle seat, for example. The child carrier 14 further includes a harness 25 to restrain the child in the child-receiving space 22 and may include seat attachments, such as anchors or a belt path which can be used to attach the child carrier 14 to a vehicle seat.

In illustrative embodiments, the child transporter 10 further includes a carrier cover 16 configured to be deployed selectively to at least partially surround the child seated in the child receiving space 22 as shown in FIG. 3. The carrier cover 16 is coupled with the footrest 30 and movable from a storage configuration 27, as shown in FIG. 2, to an expanded configuration 29 as shown in FIG. 3. In the storage configuration, the carrier cover 16 is stored in the carrier-cover compartment 38 of the footrest 30. In the expanded configuration 29, the carrier cover 16 is withdrawn from the carrier-cover compartment 38 and attaches to portions of the child seat 21 to provide an enclosed space at least partially surrounding the child.

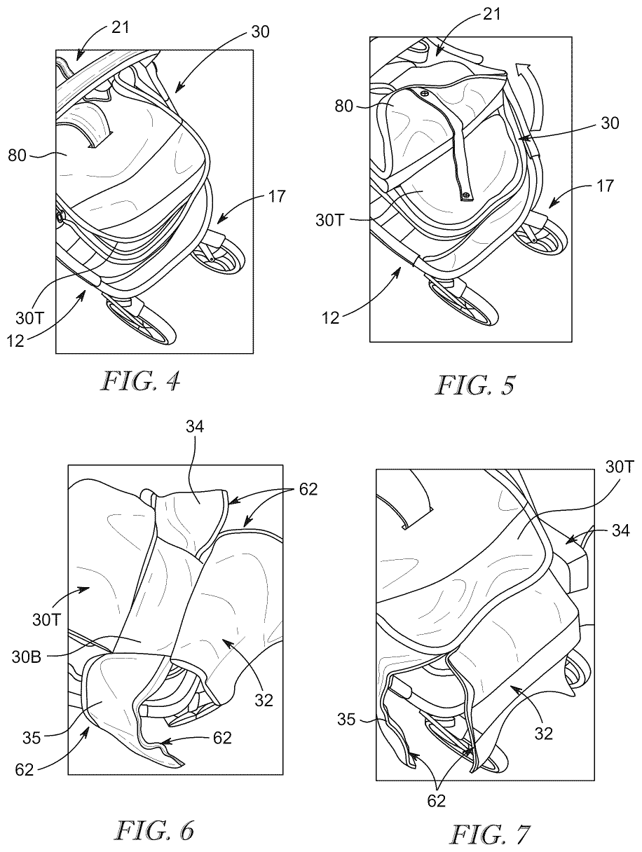

The footrest 30 includes a top cover 30T and a bottom cover 30B, and the carrier-cover compartment 38 is located between the top cover 30T and the bottom cover 30B, as shown in FIGS. 1-7. The top cover 30T is pivotable about a horizontal axis to open the carrier-cover compartment 38. The carrier cover 16 is attached at or near a distal end of the bottom cover 30B.

In the storage configuration 27, the carrier cover 16 displaces the top cover 30T in an upward direction to separate the top cover 30T from the bottom cover 30B as shown in FIG. 5. When the carrier cover 16 is withdrawn from the carrier-cover compartment 38 (i.e. in the expanded configuration 29), the top cover 30T can be fold back in place to engage an upper surface of the bottom cover 30B. This lowers an upper surface of the top cover 30T in comparison to when the carrier cover 16 is in the storage configuration and provides increased space in the upward direction between the carrier cover 16 and the top cover 30T.

The child seat 21 may be pivotable relative to the frame 12 between an upright-seating position and a laid-back position to arrange the child seat 21 in a bassinet mode when the carrier cover 16 is in the expanded configuration 29 and the child seat 21 is in the laid-back position. In the bassinet mode, walls along a perimeter of the footrest 30 provide a boundary of the child receiving space to help confine the child. The increased space provided by the top cover 30T engaging the bottom cover 30B also helps confine the child.

The carrier cover 16 includes a top panel 32, a first side panel 34, a second side panel 35, and a plurality of zippers 62, as shown in FIGS. 1-3 and 8-11. The top panel 32 is coupled at or near the distal end of the bottom cover 30B. The first side panel 34 is coupled to a first lateral side 32R of the top panel 32 and a first lateral side 21R of the child seat 21 in the expanded configuration 29. The second side panel 35 is coupled to a second lateral side 32L of the top panel 32 and a second lateral side 21L of the child seat 21 in the expanded configuration 29. The plurality of zippers 62 interconnect the first and second side panels 34, 35 to the top panel 32 and to the child seat 21. In some embodiments, the first and second side panels 34, 35 may be attached to the frame 12 in addition to or alternatively to the child seat 21.

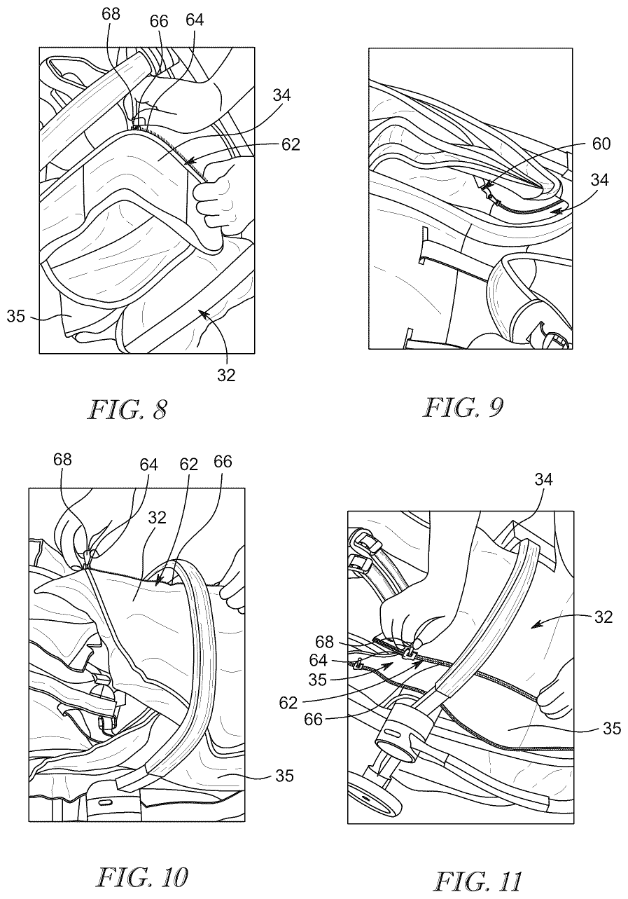

Each of the plurality of zippers 62 includes a zipper head 64, a zipper track 66, and a zipper tether 60, as shown in FIGS. 8-11. The zipper head 64 is configured to be gripped by a user to open and close the zipper 62. The zipper track 66 includes a first half coupled to an edge of a first component to be fastened together (e.g. first side panel 34) and a second half coupled to an edge of a second component to be fastened together with the first component (e.g. the child seat 14) is configured to be opened and closed by the zipper head 64. The zipper tether 60 is coupled to the zipper head 64 to engage selectively with a corresponding retainer on the child seat to retain the zipper in a closed position when the carrier cover 16 is in the expanded configuration 29. The zipper tether 60 can include a clip, a buckle, a snap, a magnet, or any other suitable structure that can retain the zipper head 64 in the closed position. The zippers 62 are shown as being visible to aid in understanding of the present disclosure, however, panels 32, 34, 35 can include extensions that overly the zipper track 66 to hide the track 66 from view in the expanded configuration. The zipper tethers 60 are optional in some embodiments.

The top panel 32 includes a flexible sheet 70 and a plurality of relatively rigid supports 72 coupled to the flexible sheet 70, as shown in FIGS. 2 and 3. The flexible sheet 70 allows the top panel 32 to be folded for storage in the storage configuration. The rigid supports 72 extend between the first lateral side 32R of the top cover 32 and the second lateral side 32L of the top cover 32 to block sagging of the top cover 32 in a downward direction toward the seating surface 23 in the expanded configuration 29. In an illustrative embodiment, each of the rigid supports 72 are curved.

In some embodiments, the juvenile stroller 10 (also called a child transporter 10) includes a rolling stroller frame 12, a child carrier 14 mounted to the rolling stroller frame 12, and a stowable-carrier cover 16 coupled to the child carrier 14 as shown in FIGS. 1-11. The juvenile stroller 10 is configured to be used by a caregiver to transport a child supported in the child carrier 14.

The child carrier 14 can be changed from a seat-open mode to a seat-carriage mode by deploying the stowable-carrier cover 16 from a storage configuration to an expanded configuration as suggested in FIGS. 1-11. In the seat-open mode, portions of the child carrier 14 are uncovered. In the seat-carriage mode, said portions of the child carrier 14 are covered by the stowable-carrier cover 16 to provide at least a partially enclosed space for the child, such as around the child's legs, pelvis, torso, etc.

The child carrier 14 includes a seat bottom 18 and a seat back 20 extending from the seat bottom 18 as shown in FIGS. 1-11. The seat bottom 18 and the seat back 20 cooperate to define a child-receiving surface or space 22 for a child and an outward-facing surface 24 arranged opposite to the child-receiving surface 22. The child carrier 14 may further include a bumper bar 26 extending outwardly from the child-receiving surface 22 coupled to one of the seat bottom 18 and the seat back 20. The seat back 20 may include a canopy 28 configured to cover and upper portion of the child (i.e. head, neck shoulders, chest) while the carrier cover 16 covers the lower portions of the child. The seat bottom 18 is formed to include a foot panel 30. The foot panel 30 is formed to include a carrier-cover compartment 38 to hold the stowable-carrier cover 16 in the storage configuration.

The stowable-carrier cover 16 includes a top panel 32, a first side panel 34, and a second side panel 35 as shown in FIGS. 1-11. A proximal end 32A of the top panel 32 is integrally coupled to the foot panel 30 of the child carrier 14. The first side panel 34 and the second side panel 35 may be coupled to the proximal end 32A of the top panel 32 or to the foot panel 230 at a location adjacent to the proximal end 232A.

In the illustrative embodiment, foot panel 30 includes a bottom cover 30B and a top cover 30T. The top cover 30T is spaced apart from the bottom cover 30B to provide the carrier-cover compartment 38 therebetween. The stowable-carrier cover 16 is coupled to an upward-facing surface 30U of the bottom cover 30B. In other embodiments, the stowable-carrier cover 16 may be coupled to other portions of the foot panel 30. In some embodiments, the child carrier 14 may be formed to include more than one carrier-cover compartment 38 and/or the juvenile stroller 10 may have more than one stowable-carrier cover 16 configured to cover portions of the seat back 20 and increase the enclosed space beyond a terminal end 32B of the top panel 32. The child carrier 14 further includes soft goods 80 that overlie the child seat 21 and the footrest 30.

In the storage configuration, the stowable-carrier cover 16 is folded into the carrier-cover compartment 38 between the bottom cover 30B and the top cover 30T as shown in FIGS. 1-11. In the illustrative embodiment, the stowable-carrier cover 16 includes one or more zippers to attach the side panels 34, 35 to the foot panel 30, the seat bottom 18, and/or the seat back 20 and to the top panel 32. The child carrier 14 may further include tethers 60 configured to attach to zipper heads when fully closed to retain the zipper(s) in a closed position. In other embodiments, other fastening means may be used, such as hook-and-loop fastener(s), button(s), or snap(s). As described above, the proximal end 32A of the top panel 32 is integrally coupled to foot panel 30 within the carrier-cover compartment 38. In other words, the first end 32A may not be configured to be detached from the foot panel 30.

In the expanded configuration, the carrier-cover compartment 38 is unzipped and the stowable-carrier cover 16 is pulled or stretched over/along the child carrier 14 as shown in FIGS. 1-11. Specifically, the main body 32 extends from the carrier-cover compartment 38 along the foot panel 30 and portions of the seat bottom 218 and/or seat back 20. As such, the main body 32 encloses a space at a mid to foot end of the child carrier 14.

The present disclosure includes stowable-carrier cover means 16 for providing a seat-carriage mode for a child carrier 14 as shown in FIGS. 1-11. The seat-carriage mode for the child carrier 14 provides an enclosed environment for an occupant of the stroller. The stowable-carrier cover means 16 may be permanently fixed to the child carrier 14.

The stowable-carrier cover means 16 is stowed within the foot panel 30 of the child carrier 14 in the carrier-cover compartment 38 in a storage configuration as shown in FIG. 1. A caregiver unzips the carrier-cover compartment 38 and unfolds the stowable-carrier cover means 16 from the carrier-cover compartment 38 to transition the stowable-carrier cover means 16 from the storage configuration to the expanded configuration. In the expanded configuration, the stowable-carrier cover means 16 is fastened to anchor points on the outward-facing surface 24, the canopy 28, and/or around the stroller hubs 44 to enclose a foot end of the child carrier 14 and the sides of the child carrier 14 and establish the seat-carriage mode of the child carrier 14 as shown in FIGS. 1-11. The seat-carriage mode of the child carrier 14 provides an enclosed area free of entrapments.

The stowable-carrier cover means 16 may comprise lightweight, stretchable fabric to allow for the stowable-carrier cover means 16 to change between the storage configuration and the expanded configuration. In some embodiments, the carrier cover 16 includes panels or segments of a relatively rigid or partially rigid material that can be unfolded from the carrier-cover compartment and deployed at least partially around the child receiving space of the child carrier 14.

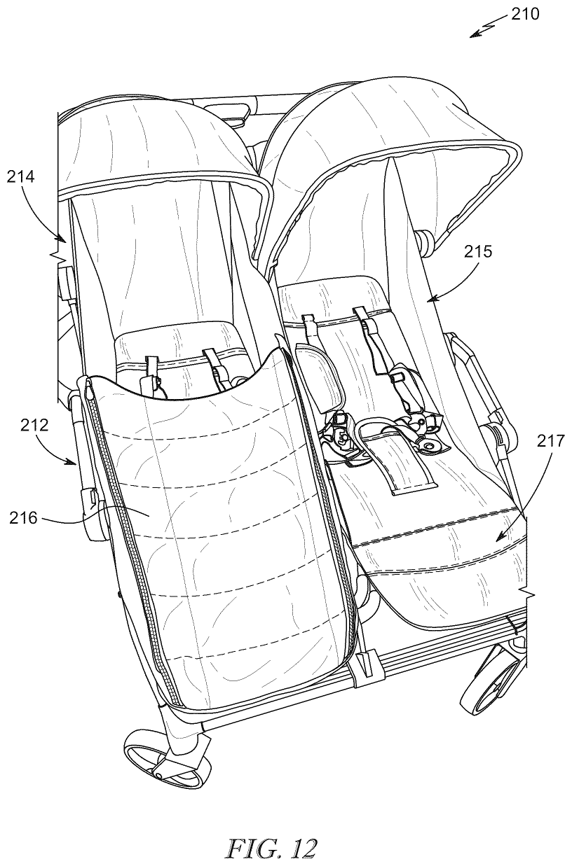

A second embodiment of a juvenile stroller 210 in accordance with the present disclosure includes a rolling stroller frame 212, a child carrier 214 mounted to the rolling stroller frame 212, and a stowable-carrier cover 216 coupled to the child carrier 214 as shown in FIG. 12. The juvenile stroller 210 is configured to be used by a caregiver to transport a child supported in the child carrier 214. The juvenile stroller 210 further includes a second child carrier 215 coupled to the stroller frame 212 and positioned next to the child carrier 214. Both the child carrier and the second child carrier 215 can include their own stowable-carrier cover 216, 217, or only one of the child carriers 214, 215 can include a single stowable-carrier cover 216 that surrounds a portion of both the child carrier 214 and the second child carrier 215 to provide an enclosed space for both of the child carriers 214, 215. The stowable-carrier cover 216 is substantially the same as stowable-carrier cover 16.

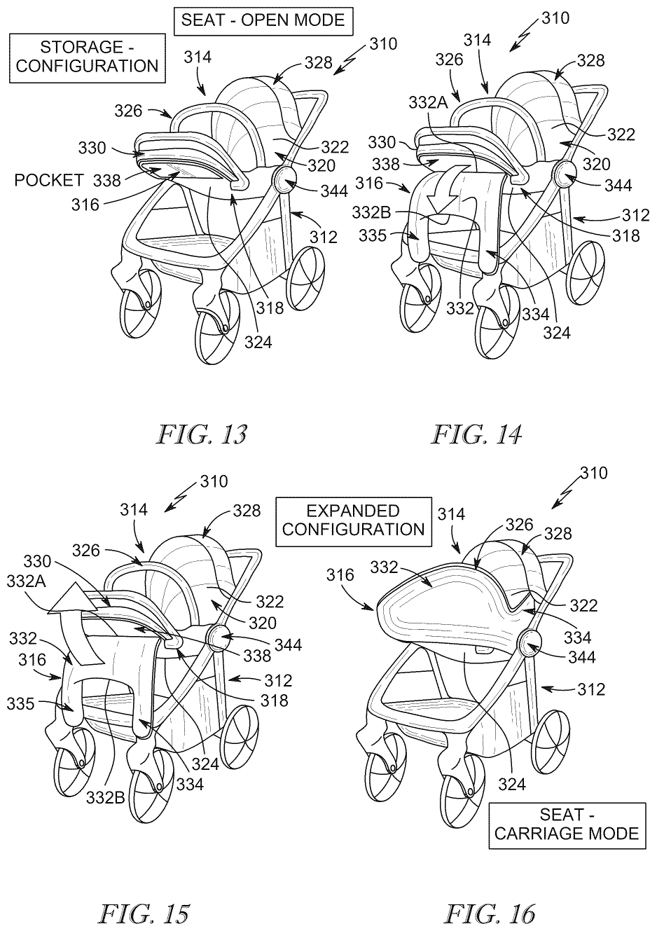

A third embodiment of a juvenile stroller 310 in accordance with the present disclosure is shown in FIGS. 13-16. The juvenile stroller 310 includes a rolling stroller frame 312, a child carrier 314 mounted to the rolling stroller frame 312, and a stowable-carrier cover 316 coupled to the child carrier 314 as shown in FIGS. 13-16. The juvenile stroller 310 is configured to be used by a caregiver to transport a child supported in the child carrier 314.

The child carrier 314 can be changed from a seat-open mode to a seat-carriage mode by deploying the stowable-carrier cover 316 from a storage configuration to an expanded configuration as suggested in FIGS. 13-16 and described below. In the seat-open mode, portions of the child carrier 314 are uncovered. In the seat-carriage mode, portions of the child carrier 314 are covered by the stowable-carrier cover 316 to provide at least a partially enclosed space for the child.

The child carrier 314 includes a seat bottom 318 and a seat back 320 extending from the seat bottom 318 as shown in FIGS. 13-16. The seat bottom 318 and the seat back 320 cooperate to define a child-receiving surface 322 for a child and an outward-facing surface 324 arranged opposite to the child-receiving surface 322. The child carrier 314 may further include a bumper bar 326 extending outwardly from the child-receiving surface 322 coupled to one of the seat bottom 318 and the seat back 320. The seat bottom 318 is formed to include a foot panel 330. The outward-facing surface 324 is formed to include a carrier-cover compartment 338 to hold the stowable-carrier cover 316 in the storage configuration. The seat back 320 includes a canopy 328.

The stowable-carrier cover 316 includes a main body 332, an upper left arm 334, an upper right arm 335, a lower left arm 336, and a lower right arm 337 as shown in FIGS. 13-16. A first end 332A of the main body 332 is integrally coupled to the outward-facing surface 324 of the child carrier 314. The upper left arm 334 and the upper right arm 335 are coupled to a second end 332B of the main body 332. The lower left arm 336 and the lower right arm 337 branch from the upper left arm 334 and the upper right arm 335, respectively.

In the illustrative embodiment, the stowable-carrier cover 316 is coupled to the outward-facing surface 324 at the footrest 330 of the seat bottom 318. In other embodiments, the stowable-carrier cover 316 may be coupled to other portions of the outward-facing surface 324. In some embodiments, the outward-facing surface may be formed to include more than one carrier-cover compartment 338 and/or the juvenile stroller 310 may have more than one stowable-carrier cover 316.

In the storage configuration, the stowable-carrier cover 316 is folded into the carrier-cover compartment 338 and secured to the outward-facing surface 324 as shown in FIG. 13. In the illustrative embodiment, the stowable-carrier cover 316 zips into the carrier-cover compartment 338 to arrange the stowable-carrier cover 316 in the storage configuration. In other embodiments, other fastening means may be used, such as hook-and-loop fastener(s), button(s), or snap(s). As described above, the first end 332A of the main body 332 is integrally coupled to the outward-facing surface 324 within the carrier-cover compartment 338. In other words, the first end 332A is not configured to be detached from the outward-facing surface 324.

In the expanded configuration, the carrier-cover compartment 338 is unzipped and the stowable-carrier cover 316 is stretched over the child carrier 314 as shown in FIGS. 14-16. Specifically, the main body 332 extends from the outward-facing surface 324 to the bumper bar 326 by stretching over and around the foot panel 330. As such, the main body 332 encloses a space defined between the bumper bar 326 and the child-receiving surface 22 at a foot end of the child carrier 314 as shown in FIGS. 13-16.

In addition, in the expanded configuration, the upper left arm 334 and the upper right arm 335 extend from the second end 332B of the main body 332 to the canopy 328. The upper left arm 334 and the upper right arm 335 are approximately perpendicular to the child-receiving surface 322 and attach to respective anchor points 340 coupled to the inside of the canopy 328 at a head end of the child carrier 314. As such, the upper left arm 334 and the upper right arm 335 cooperate with the canopy 328 and the main body 332 to enclose the sides of the child carrier 314. The upper left arm 334 and the upper right arm 335 may attach to the anchor points 340 with hook-and-loop fasteners, buttons, snaps, or other suitable fastening means.

Furthermore, in the expanded configuration, the lower left arm 336 and the lower right arm 337 extend from a child-facing end of the upper left arm 334 and the upper right arm 335, respectively, to the outward-facing surface 324. The left arm 336 and the lower right arm 337 wrap from the sides of the juvenile carrier 314 to anchor points 342 coupled to the outward-facing surface 324. As such, the lower left arm 336 and the lower right arm 337 cooperate to secure the stowable-carrier cover 316 in the expanded configuration and provide a continuous enclosure on the sides of the child carrier 314. The lower left arm 336 and the lower right arm 337 may attach to the anchor points 342 with hook-and-loop fasteners, buttons, snaps, or other suitable fastening means.

The main body 332 and the lower left and right arm 336, 337 also anchor the stowable-carrier cover 316 to a stroller hub 344 on either side of the rolling stroller frame 312. The main body 332 may attach to anchor points 346 coupled to the stroller hub 344 on either side of the rolling stroller frame 312. Similarly, the lower left and right arm 336, 337 may attach to anchor points 348 coupled to the stroller hub 344 on either side of the rolling stroller frame 312. The main body and the lower left and right arm 336, 337 may attach to the respective anchor points 346, 348 with hook-and-loop fasteners, buttons, snaps, or other suitable fastening means. As such, the stowable-carrier cover 316 is further secured in the expanded configuration.

The present disclosure includes stowable-carrier cover means 316 for providing a seat-carriage mode for a child carrier 314. The seat-carriage mode for the child carrier 314 provides an enclosed environment for an occupant of the stroller. The stowable-carrier cover means 316 may be permanently fixed to the child carrier 314.

The stowable-carrier cover means 316 is stowed underneath a foot panel 330 of the child carrier 314 within a carrier-cover compartment 338 in a storage configuration as shown in FIG. 13. A caregiver unzips the carrier-cover compartment 338 and unfolds the stowable-carrier cover means 316 from the carrier-cover compartment 338 to transition the stowable-carrier cover means 316 from the storage configuration to the expanded configuration as shown is FIGS. 14 and 15. In the expanded configuration, the stowable-carrier cover means 316 is stretched over the bumper bar 338 and fastened to anchor points on the outward-facing surface 324, the canopy 328, and around the stroller hubs 344 to enclose a foot end of the child carrier 314 and the sides of the child carrier 314 and establish the seat-carriage mode of the child carrier 314. The seat-carriage mode of the child carrier 314 provides an enclosed area free of entrapments. The stowable-carrier cover means 316 may comprise lightweight, stretchable fabric to allow for the stowable-carrier cover means 316 to change between the storage configuration and the expanded configuration.

1. A child transporter comprising
a frame including a chassis, a plurality of wheels coupled to the chassis to support the chassis above ground, and a handle coupled to the chassis and configured to be gripped and maneuvered by a user to move the frame over the ground,
a child carrier coupled to the chassis and formed to include a child-receiving space configured to hold a child to transport the child, the child carrier including a child seat having a seating surface for the child and a footrest coupled to the child seat to support legs of the child and formed to include a carrier-cover compartment, and
a carrier cover coupled with the footrest and movable from a storage configuration, in which the carrier cover is stored in the carrier-cover compartment of the footrest, and an expanded configuration, in which the carrier cover is withdrawn from the carrier-cover compartment and attaches to portions of the child seat to provide an enclosed space at least partially surrounding the child.

2. The child transporter of claim 1, wherein the footrest includes a top cover and a bottom cover and the carrier-cover compartment is located between the top cover and the bottom cover.

3. The child transporter of claim 2, wherein the top cover is pivotable about a horizontal axis to open the carrier-cover compartment.

4. The child transporter of claim 3, wherein the carrier cover is attached near a distal end of the bottom cover.

5. The child transporter of claim 2, wherein, in the storage configuration, the carrier cover displaces the top cover in an upward direction to separate the top cover from the bottom cover, and, in the expanded configuration, the top cover engages an upper surface of the bottom cover to lower an upper surface of the top cover and provide increased space in the upward direction between the carrier cover and the top cover in the expanded configuration.

6. The child transporter of claim 5, wherein the child seat is pivotable relative to the frame between an upright-seating position and a laid-back position to arrange the child seat in a bassinet mode when the carrier cover is in the expanded configuration and the child seat is in the laid-back position.

7. The child transporter of claim 1, wherein the carrier cover includes a top panel, a first side panel coupled to a first lateral side of the top panel and a first lateral side of the child seat in the expanded configuration, and a second side panel coupled to a second lateral side of the top panel and a second lateral side of the child seat in the expanded configuration.

8. The child transporter of claim 7, wherein the carrier cover further includes a plurality of zippers interconnecting the first and second side panels to the top panel and to the child seat.

9. The child transporter of claim 8, wherein each zipper includes a zipper head, a zipper track configured to be opened and closed by the zipper head, and a zipper tether coupled to the zipper head to engage selectively with a corresponding retainer on the child seat to retain the zipper in a closed position when the carrier cover is in the expanded configuration.

10. The child transporter of claim 8, wherein the top panel includes a flexible sheet and a plurality of relatively rigid supports coupled to the top sheet.

11. The child transporter of claim 10, wherein the rigid supports extend between the first lateral side of the top cover and the second lateral side of the top cover to block sagging of the top cover in a downward direction toward the seating surface in the expanded configuration.

12. The child transporter of claim 10, wherein each of the rigid supports are curved.

13. A child restraint comprising
a child seat having a seating surface for a child,
a footrest coupled to the child seat to support legs of the child and formed to include a carrier-cover compartment, and
a carrier cover coupled with the footrest and movable from a storage configuration, in which the carrier cover is stored in the carrier-cover compartment of the footrest, and an expanded configuration, in which the carrier cover is withdrawn from the carrier-cover compartment and attaches to portions of the child seat to provide an enclosed space at least partially surrounding the child.

14. The child restraint of claim 13, wherein the footrest includes a top cover and a bottom cover and the carrier-cover compartment is located between the top cover and the bottom cover.

15. The child restraint of claim 14, wherein the top cover is pivotable about a horizontal axis to open the carrier-cover compartment.

16. The child restraint of claim 14, wherein, in the storage configuration, the carrier cover displaces the top cover in an upward direction to separate the top cover from the bottom cover, and, in the expanded configuration, the top cover engages an upper surface of the bottom cover to lower an upper surface of the top cover and provide increased space in the upward direction between the carrier cover and the top cover in the expanded configuration.

17. The child restraint of claim 16, wherein the child seat is pivotable relative to the frame between an upright-seating position and a laid-back position to arrange the child seat in a bassinet mode when the carrier cover is in the expanded configuration and the child seat is in the laid-back position.

18. The child restraint of claim 13, wherein the carrier cover includes a top panel, a first side panel coupled to a first lateral side of the top panel and a first lateral side of the child seat in the expanded configuration, and a second side panel coupled to a second lateral side of the top panel and a second lateral side of the child seat in the expanded configuration.

19. The child restraint of claim 18, wherein the carrier cover further includes a plurality of zippers interconnecting the first and second side panels to the top panel and to the child seat.

20. The child restraint of claim 19, wherein each zipper includes a zipper head, a zipper track configured to be opened and closed by the zipper head, and a zipper tether coupled to the zipper head to engage selectively with a corresponding retainer on the child seat to the zipper in a closed position when the carrier cover is in the expanded configuration.
